(19) United States
(12) Patent Application Publication
(10) Pub. No.: US 2026/0257649 A1
(43) Pub. Date: Sep. 3, 2026

(54) VEHICLE AND METHOD FOR CONTROLLING VEHICLE WINDSHIELD MOISTURE PRECONDITIONING

(71) Applicant: Ford Global Technologies, LLC, Dearborn, MI (US)

(72) Inventors: Robert Schroeter, Livonia, MI (US); Mahmoud Yousef Ghannam, Canton, MI (US); Alan Gutowski, Wixom, MI (US)

(73) Assignee: Ford Global Technologies, LLC, Dearborn, MI (US)

(21) Appl. No.: 19/068,053

(22) Filed: Mar. 3, 2025

(51) Int. Cl. B60S 1/02; B60H 1/00; G01N 19/10

(52) U.S. Cl. CPC B60S 1/026; B60H 1/00785; G01N 19/10

(57) ABSTRACT

A vehicle has a body defining a cabin interior, a windshield, a windshield conditioning system, a location determining device for determining a location of the vehicle, one or more vehicle sensors for assessing a likelihood of moisture on the windshield, a remote assessment device for assessing ambient environmental conditions proximate to the vehicle, and a controller configured to perform a preconditioning strategy to defog or defrost the windshield with the windshield conditioning system. The controller controls the preconditioning strategy based on a weighted proportion of the likelihood of moisture assessed the one or more vehicle sensors and the ambient environmental conditions assessed with the remote assessment device. The weighted proportion is determined based on the determined location of the vehicle.

### FIELD OF THE DISCLOSURE

The present disclosure generally relates to vehicle window defogging and defrosting, and more particularly relates to preconditioning a motor vehicle to remove moisture from a window such as the windshield.

### BACKGROUND OF THE DISCLOSURE

Motor vehicles are commonly equipped with windshield defogging and defrosting devices to remove moisture from the windshield of the motor vehicle. Window defogging and defrosting generally consumes energy and thus may impact the travel range of vehicles such as battery electric vehicles and hybrid electric vehicles, particularly while experiencing cold temperatures and humid conditions. Some motor vehicles offer preconditioning of the cabin interior prior to driving the vehicle. It may be desirable to provide for a method of preconditioning the cabin interior to efficiently provide moisture control to defog or defrost the windshield.

### SUMMARY OF THE DISCLOSURE

According to a first aspect of the present disclosure, a vehicle has a body defining a cabin interior, a windshield, a windshield conditioning system, a location determining device for determining a location of the vehicle, one or more vehicle sensors for assessing a likelihood of moisture on the windshield, a remote assessment device for assessing ambient environmental conditions proximate to the vehicle, and a controller configured to perform a preconditioning strategy to defog or defrost the windshield with the windshield conditioning system. The controller controls the preconditioning strategy based on a weighted proportion of the likelihood of moisture assessed the one or more vehicle sensors and the ambient environmental conditions assessed with the remote assessment device. The weighted proportion is determined based on the determined location of the vehicle.

Embodiments of the first aspect of the present disclosure can include any one or a combination of the following features:
the one or more vehicle sensors include one or more of an ambient temperature sensor, a solar load sensor, an evaporator temperature sensor, a windshield temperature sensor, a relative humidity sensor, and a dewpoint temperature sensor;
the remote assessment device comprises one or more of a cloud based service and a weather application;
a remote start device, wherein the remote start device initiates the preconditioning strategy;
the remote start device comprises a key fob;
the remote start device comprises a mobile device having a software application;
the windshield conditioning system comprises one or more defogger or defrost devices;
the one or more defogger or defrost devices comprises one or more of an airflow defogger and a heating element;
an electric battery for supplying electrical power to the vehicle, wherein the electric battery supplies energy to power the one or more defogger and defrost devices; and
the location determining device determines whether the vehicle is located in an indoor environment or an outside environment.

A method of preconditioning a vehicle to provide window defogging on a windshield is included in the present disclosure. The method includes the steps of determining a location of the vehicle, assessing a likelihood of moisture on the windshield with one or more vehicle sensors, assessing ambient environmental conditions proximate to the vehicle with a remote assessment device, and determining a weighted proportion of the likelihood of moisture assessed with the one or more vehicle sensors and the ambient environmental conditions assessed with the remote assessment device. The weighted proportion is determined based on the determined location of the vehicle. The method may further include performing a conditioning strategy with a windshield conditioning system to defog or defrost the windshield based on the weighted proportion.

Embodiments of the second aspect of the present disclosure can include any one or a combination of the following features:
the method step of assessing the likelihood moisture on the windshield comprises sensing one or more moisture related parameters on the windshield with one or more sensors that includes one or more of an ambient temperature sensor, a solar load sensor, an evaporator temperature sensor, a windshield temperature sensor, a relative humidity sensor, and a dewpoint temperature sensor;
the remote assessment device comprises one or more of a cloud based service and a weather application;
a remote start device, wherein the remote start device initiates the preconditioning strategy;
the remote start device comprises a key fob;
the remote start device comprises a mobile device having a software application;
the windshield conditioning system comprises one or more defogger or defrost devices;
the one or more defogger or defrost devices comprises one or more of an airflow defogger and a heating element;
an electric battery for supplying electrical power to the vehicle, wherein the electric battery supplies energy to power the one or more defogger and defrost devices; and
the location determining device determines whether the vehicle is located in an indoor environment or an outside environment.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top schematic view of a motor vehicle equipped with a windshield conditioning system having a preconditioning control strategy for removing moisture from a windshield;

FIG. 2 is a block diagram of the motor vehicle windshield conditioning system, according to one example;

FIG. 3 is a flow diagram illustrating the motor vehicle windshield conditioning system configured with a preconditioning control strategy;

FIG. 4 is a logic diagram illustrating preconditioning of the motor vehicle using weighted signals based on assessments from vehicle sensors and external sources; and

FIG. 5 is a flow diagram illustrating a control routine for performing motor vehicle preconditioning of a vehicle windshield, according to one embodiment.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

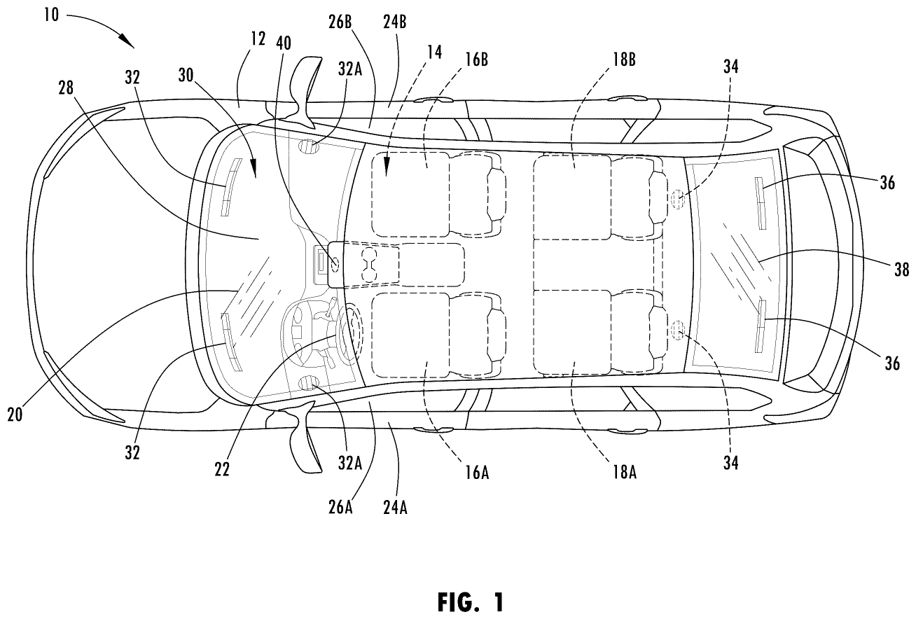

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a motor vehicle and method of preconditioning a cabin interior of the motor vehicle to remove moisture from a windshield. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1-5, a motor vehicle 10 is generally illustrated equipped with a preconditioning system 30 for preconditioning a vehicle window, particularly a vehicle windshield 20 to remove moisture from the windshield prior to driving the motor vehicle 10. The motor vehicle 10 includes a vehicle body 12 defining a cabin interior 14 and the windshield 20. The motor vehicle 10 further includes a location determining device for determining a location of the motor vehicle 10 and one or more vehicle sensors for assessing a likelihood of moisture on the windshield. The motor vehicle 10 further includes a remote assessment device for accessing ambient environmental conditions proximate to the motor vehicle 10, and a controller 50 configured to perform a preconditioning strategy to defog or defrost the windshield 20. The controller 50 controls the defogging or defrosting based on a weighted proportion of the moisture assessed with the one or more vehicle sensors and ambient conditions assessed with the remote communication device. The weighted proportion is determined based on the determined location of the vehicle.

With particular reference to FIG. 1, the motor vehicle 10 is generally shown having a vehicle body 12 defining an interior cabin, referred to as a passenger compartment 14. The motor vehicle 10 may be configured as a wheeled motor vehicle such as a sedan, a sport utility vehicle (SUV), a van, a truck, a bus or other motorized vehicle configured to transport one or more passengers. The passenger compartment 14 is generally defined by the vehicle body 12 and is configured with a seating arrangement. The seating arrangement shown in one example includes first and second rows of seating including first and second front row seats 16A and 16B and third and fourth rear row seats 18A and 18B. The seating arrangement may include seats arranged in more than two rows of seating and other seating configurations. Front row seats 16A-16B and rear row seats 18A-18B are generally supported on a vehicle floor and are shown arranged to seat passengers oriented generally facing forward in the motor vehicle 10.

The motor vehicle 10 includes a front window, referred to as a windshield 20, generally located at the upper forward end of the passenger compartment 14 and generally above a dashboard 28 and below and abutting a front end of the cabin roof. The windshield 20 is generally visually transparent and may be susceptible to the accumulation of moisture such as fog and frost on a surface thereof. The motor vehicle 10 also has a steering wheel 22 positioned generally in front of front row seat 16A which serves as a driver's seat. Access side doors, including front side door 24A and opposite side front side door 24B, allow access to the cabin interior 14 of the motor vehicle 10. It should be appreciated that additional access doors may be located such as proximate to the second row of seating. Each of the side doors 26A and 26B includes a window, shown as side windows 26A and 26B.

The motor vehicle 10 is equipped with a windshield conditioning system 30 which may include a heating, ventilation and air conditioning system (HVAC) which may also be configured to provide window moisture removal conditioning to precondition the windows, including the windshield 20, prior to the motor vehicle 10 being driven and to further condition the windows, including the windshield 20, while the motor vehicle 10 is being driven. Included with the windshield conditioning system 30 is a pair of defogger or defroster devices 32 generally shown having outlets located within a forward portion of the dashboard 28 and operatively coupled to air ducts and oriented to allow air to be blown under pressure via a fan onto the inner surface of the windshield 20. It should be appreciated that the defogger or defroster devices 32 may be used for defrosting and defogging the windshield 20 which may remove frozen moisture in the form of frost from the windshield 20 as well as to remove liquid moisture in the form of fog from the windshield 20 by blowing conditioned air on to the interior surface of the windshield 20. The windshield conditioning system 30 may further include a pair of defogger or defroster devices 32A shown as vent outlets generally positioned on opposite lateral sides of the motor vehicle 10 in a forward portion of the dashboard 28 to provide air flow blown via a fan towards the lateral sides, including air flow directed onto the interior surface of side windows 26A and 26B. In addition, there may be one or more defogger or defroster devices 34 located in other regions of the motor vehicle 10 such as in the rear of the passenger compartment 14 as shown with vent outlets to blow conditioned air onto an upper surface of the rear window 38. Additional defrosters or defogger devices, referred to as rear defrosters or defogger devices 36, may be located as shown with outlets at the rear of the motor vehicle 10 and positioned to direct conditioned air onto a lower inner surface of a rear window 38 at the rear end of the passenger cabin 14.

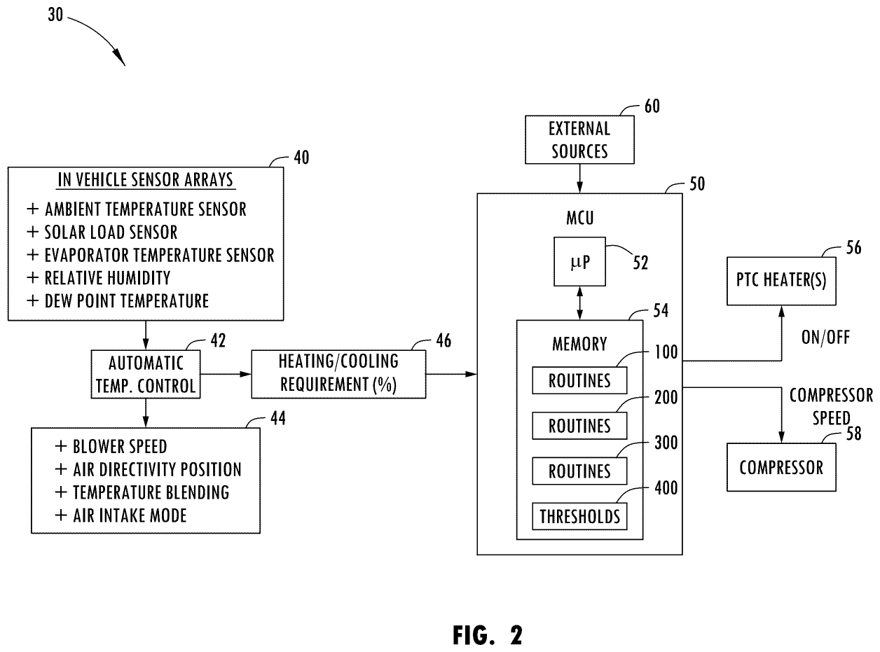

The windshield conditioning system 30 is illustrated further in FIG. 2 having an array of onboard vehicle sensors 40 for sensing environmental conditions within and proximate to the motor vehicle 10 and are used to assess a likelihood of moisture present on the windshield 20. The onboard vehicle sensors 40 may include one or more ambient temperature sensors, solar load sensors, evaporator temperature sensors, relative humidity sensors, dew point sensors and other sensors for sensing the environmental conditions inside the motor vehicle 10 and outside the motor vehicle 10 proximate to the motor vehicle 10. The sensed environmental conditions provide moisture related parameters. The windshield conditioning system 30 also includes an automatic temperature control module (ATCM) 42 for controlling the temperature and flow of conditioned air for conditioning the airflow within the motor vehicle 10. The automatic temperature control module 42 may generate control signals to control devices 44 including the air blower speed, air directivity position, temperature blending and air intake mode. The windshield conditioning system 30 further includes a heating/cooling requirement percentages module 46 which may control a proportion of heating and cooling provided in the conditioned air flowing in the motor vehicle 10.

The windshield conditioning system 30 may include a micro control unit, also referred to as a controller 50, which is configured to control various devices to provide the conditioned air within the motor vehicle 10. The controller 50 may include a microprocessor 52 and memory 54. It should be appreciated that other analog and/or digital control circuitry may be used. Stored within memory 54 and executed by a microprocessor 52 are one or routines 100 and threshold parameters 200. The windshield conditioning system 30 also receives environmental information via a remote assessment device. The remote assessment device may include one or more of a cloud based service and a weather application from one or more external sources 60 which may include information stored and retrieved from a cloud data services provider or from other external sources including communication via other vehicles and the internet via cellular signal, with one or more communication towers or satellites, for example. The controller 50 advantageously processes the control routines and provides control outputs to one or more electric heaters 56 such as positive temperature co-efficient (PTC) heaters and one or more compressors 58. As such, the one or more heaters 56 may control heat supplied to the conditioned air and the compressor 58 may provide cool air to the conditioned air. The heaters 56 advantageously raise the temperature of the glass windshield above the dew point to prevent moisture in the form of condensation. The air conditioner may advantageously be activated to reduce cabin humidity to reduce fog.

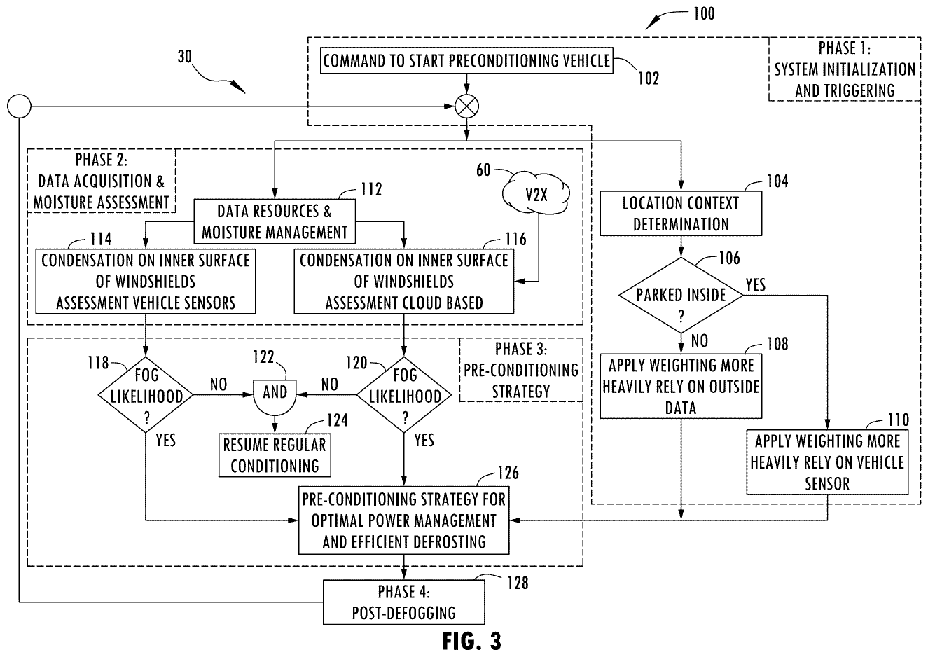

Referring to FIG. 3, the windshield conditioning system 30 is shown in a logic flow diagram for performing a routine 100 to provide pre-conditioning of air to the motor vehicle 10 to remove moisture from the windshield. Routine 100 may begin in response to a remote start device at step 102 to command a start to preconditioning the motor vehicle. The remote start device includes a key fob according to one example and a mobile device having a software application according to another example. The motor vehicle performs system initialization and triggering by proceeding to step 104 to determine the location of the motor vehicle. Routine 100 determines if the motor vehicle is parked in an indoor environment such as inside a building structure such as a garage at step 106 and, if so, applies a heavy weighting to more heavily rely on the in-vehicle sensor array. Otherwise, if the motor vehicle is determined to not be parked in an inside environment, such that the motor vehicle is parked in an outside ambient environment, routine 100 proceeds to step 108 to apply more heavily to rely on the outside environmental data. This generally completes an initial phase of the system initialization and triggering.

Returning to step 102, control routine 100 also proceeds to step 112 to perform a data resources and moisture assessment to determine the likelihood of moisture on the windshield. Control routine 100 proceeds to both step 114 to detect the likelihood of moisture (e.g., condensation) on the inner surface of the windshield based on an assessment of the in-vehicle sensors and in step 116 to detect the likelihood of moisture (e.g., condensation) on the inner surface of the windshield using the assessment from the exterior sensor source such as the cloud data service. Following step 114, routine 100 proceeds to decision step 118 to determine if there is a likelihood of fog as assessed from the in-vehicle sensors and, if so, proceeds to step 126 to perform the preconditioning strategy for optimal power management and efficient defogging and defrosting of the windshield. Following step 116, control routine 100 proceeds to decision step 120 to determine if there is a likelihood of fog or frost on the windshield based on the external sources and, if so, proceeds to step 126 to perform the preconditioning strategy with the windshield conditioning system for optimal power management and efficient defogging and defrosting. If there is no likelihood of fog or frost on the windshield as determined by decision steps 118 and 120, routine 100 via logic end gate 122 proceeds to step 124 to resume the regular conditioning of air within the motor vehicle. It should be appreciated that following the preconditioning strategy for optimal power management and efficient defogging or defrosting in step 126, routine 100 completes the preconditioning strategy and proceeds to step 128 to perform any post-defogging or post-defrosting, before returning to steps 104 and 112.

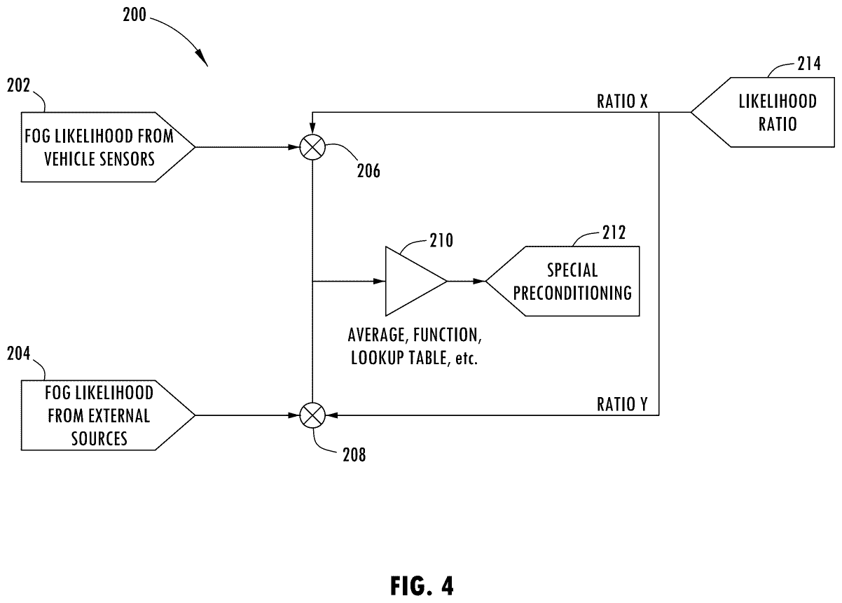

Referring to FIG. 4, the preconditioning weighting logic is illustrated in routine 200. Routine 200 processes an input determinative of the likelihood of fog or frost based on parameters sensed by the in-vehicle sensors at step 202 and also processes a fog or frost likelihood signal from external sources in step 204. A weighting ratio X is assigned based on the location context determination being that the motor vehicle is located in an indoor environment such as inside a building structure. Similarly, a weighting ratio Y is assigned based on the location context determination being that the motor vehicle is located in an outdoor environment. The weighting ratio X is multiplied by the fog or defrost likelihood vehicle signal at multiplier 206. Similarly, the weighting ratio Y is multiplied by the fog or defrost likelihood signal from the external sources at multiplier 208. The outputs of multipliers 206 and 208 are combined to provide an average value at block 210. The average value may be a computed average, or may be determined by some predetermined function or by a lookup table, for example. The average value is then provided as an input to the special preconditioning function at step 212 to precondition the windshield based on the weighted values of the vehicle internal and external sources. The weighting ratios X and Y may be supplied via a likelihood ratio input 214, for example.

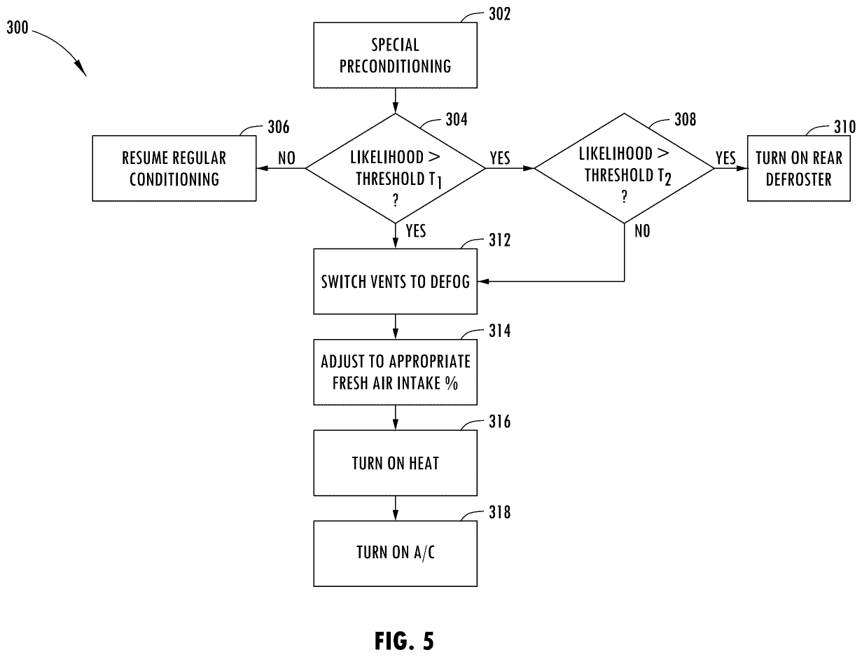

Referring to FIG. 5, one example of the special preconditioning routine 300 is provided which begins at step 302. Routine 300 proceeds to decision step 304 to determine if there is a likelihood of fog or defrost signal that is greater than a first threshold T1 and, if not, resumes the regular conditioning at step 306. If the likelihood of fog or frost signal is greater than the first threshold T1, routine 300 proceeds to step 308 to determine if the likelihood of fog or defrost is greater than a second higher threshold T2 and, if so, turns on a rear defroster at step 310. If the likelihood of fog or defrost signal is not greater than the second higher threshold T2, routine 300 proceeds to step 312 to switch the vents to the defog or defrost mode and then to step 314 to adjust to the appropriate fresh air intake percentage. Routine 300 then proceeds to turn on the heat in step 316 and to turn on the air conditioner in step 318 to thereby attempt to remove fog and/or frost from the window, particularly from the windshield.

Accordingly, it should be appreciated that the motor vehicle 10 is advantageously configured with a windshield conditioning system 30 that may precondition a window of the vehicle, such as the windshield, to remove and prevent moisture or frost from the windshield in an efficient manner, particularly based on a geographic determined location of the motor vehicle 10, such as whether the motor vehicle 10 is determined to be in an interior environment or an exterior environment. By preconditioning the motor vehicle 10 prior to use of the motor vehicle, the condition of the window, such as the windshield, may be efficiently prepared for driving use in a manner that minimizes the consumption of electric power stored within one or more batteries of the motor vehicle. For example, for a battery electric vehicle or a plug-in hybrid electric vehicle, the motor vehicle 10 may be pre-conditioned while the motor vehicle is plugged in and supplied electric energy from an electric charging station, thereby preventing discharge of the electric batteries on the motor vehicle 10. In order to conserve battery energy, the preconditioning strategy may be achieved while the motor vehicle 10 is still plugged into the electric charging station in order to optimize the battery performance for the overall driving range. It should be appreciated that the design of the motor vehicle 10 such as the geometry, in-cabin space, windshield contour and other design parameters are predefined and may be considered during the initialization and analysis phases.

The preconditioning strategy may consider factors in the parking condition, such as whether the motor vehicle 10 is parked in a home garage, a structure, an open lot or other parking conditions. It should further be appreciated that the conditioning strategy may include a link or connection to road conditions, such as tunnels, mountains and geographic areas which may be subject to fog-exacerbating conditions, such as high winds, and shifts in temperature that may be taken into consideration during the preconditioning strategy.

It is to be understood that variations and modifications can be made on the aforementioned structure without departing from the concepts of the present disclosure, and further it is to be understood that such concepts are intended to be covered by the following claims unless these claims by their language expressly state otherwise.

1. A vehicle comprising:
a body defining a cabin interior;
a windshield;
a windshield conditioning system;
a location determining device for determining a location of the vehicle;
a plurality of vehicle sensors for sensing environmental conditions within and proximate to the vehicle;
a remote assessment device for receiving environmental information for ambient environmental conditions proximate to the vehicle; and
a controller configured to assess a likelihood of moisture on the windshield based on the sensed environmental conditions and the received environmental information and to perform a preconditioning strategy to defog or defrost the windshield with the windshield conditioning system, wherein the controller controls the preconditioning strategy based on a weighted proportion of the sensed environmental condition sensed with the one or more vehicle sensors and the ambient environmental conditions received with the remote assessment device, and wherein the weighted proportion is determined based on the determined location of the vehicle.

2. The vehicle of claim 1, wherein the plurality of vehicle sensors includes at least two of an ambient temperature sensor, a solar load sensor, an evaporator temperature sensor, a windshield temperature sensor, a relative humidity sensor, and a dewpoint temperature sensor.

3. The vehicle of claim 2, wherein the remote assessment device comprises one or more of a cloud based service and a weather application.

4. The vehicle of claim 1, further comprising a remote start device, wherein the remote start device initiates the preconditioning strategy.

5. The vehicle of claim 4, wherein the remote start device comprises a key fob.

6. The vehicle of claim 5, wherein the remote start device comprises a mobile device having a software application.

7. The vehicle of claim 1, wherein the windshield conditioning system comprises one or more defogger or defrost devices.

8. The vehicle of claim 1, wherein the one or more defogger or defrost devices comprises one or more of an airflow defogger and a heating element.

9. The vehicle of claim 8, further comprising an electric battery for supplying electrical power to the vehicle, wherein the electric battery supplies energy to power the one or more defogger and defrost devices.

10. The vehicle of claim 1, wherein the location determining device determines whether the vehicle is located in an indoor environment or an outside environment.

11. A method of preconditioning a vehicle to provide window defogging on a windshield, the method comprising the steps of:
determining a location of the vehicle with a location determining device;
sensing environmental conditions within and proximate to the vehicle with a plurality of vehicle sensors;
receiving environmental information for ambient environmental conditions proximate to the vehicle with a remote assessment device;
assessing with a controller a likelihood of moisture on the windshield based on the sensed environmental conditions and the received environmental information;
determining a weighted proportion of the likelihood of moisture assessed with the controller based on the sensed environmental conditions and the received environmental information, wherein the weighted proportion is determined based on the determined location of the vehicle; and
performing a conditioning strategy with the controller to defog or defrost the windshield based on the weighted proportion.

12. The method of claim 11, wherein the step of sensing moisture on the windshield comprises sensing moisture on the windshield with the plurality of sensors that includes -two or more of an ambient temperature sensor, a solar load sensor, an evaporator temperature sensor, a windshield temperature sensor, a relative humidity sensor, and a dewpoint temperature sensor.

13. The method of claim 11, wherein the remote assessment device comprises one or more of a cloud based service and a weather application.

14. The method of claim 11, further comprising a remote start device, wherein the remote start device initiates the preconditioning strategy.

15. The method of claim 14, wherein the remote start device comprises a key fob.

16. The method of claim 15, wherein the remote start device comprises a mobile device having a software application.

17. The method of claim 11, wherein the windshield conditioning system comprises one or more defogger and defrost devices.

18. The method of claim 11, wherein the one or more defogger or defrost devices comprises one or more of an airflow defogger and a heating element.

19. The method of claim 18, further comprising an electric battery for supplying electrical power to the vehicle, wherein the electric battery supplies energy to power the one or more defogger or defrost devices.

20. The method of claim 11, wherein the location determining device determines whether the vehicle is located in an indoor environment or an outside environment.
